(19) United States
(12) Patent Application Publication
(10) Pub. No.: US 2011/0184981 A1
(43) Pub. Date: Jul. 28, 2011

(54) Personalize Search Results for Search Queries with General Implicit Local Intent

(75) Inventors: Yumao Lu, San Jose, CA (US); Fuchun Peng, Cupertino, CA (US); Benoit Dumoulin, Palo Alto, CA (US)

(73) Assignee: Yahoo! Inc., Sunnyvale, CA (US)

(21) Appl. No.: 12/694,515

(22) Filed: Jan. 27, 2010

(51) Int. Cl. G06F 17/30

(52) U.S. Cl. 707/774; 707/775; 707/E17.062; 707/E17.068

(57) ABSTRACT

One particular embodiment accesses a first set of search queries comprising one or more first search queries; extracts one or more features based on the first set of search queries, trains a search-query classifier using the features; accesses a second search query provided by a user; determines whether the second search query has implicit and general local intent using the search-query classifier; if the second search query has implicit and general local intent, then determines a location associated with the user; and identifies a search result in response to the second search query based at least in part on the location associated with the user; and presents the search result to the user.

### TECHNICAL FIELD

The present disclosure generally relates to improving the quality of search results indentified for search queries by search engines and more specifically relates to personalizing the search results indentified for the search queries having implicit and general local intent.

### BACKGROUND

The Internet provides a vast amount of information. The individual pieces of information are often referred to as “network resources” or “network contents” and may have various formats, such as, for example and without limitation, texts, audios, videos, images, web pages, documents, executables, etc. The network resources or contents are stored at many different sites, such as on computers and servers, in databases, etc., around the world. These different sites are communicatively linked to the Internet through various network infrastructures. Any person may access the publicly available network resources or contents via a suitable network device (e.g., a computer, a smart mobile telephone, etc.) connected to the Internet.

However, due to the sheer amount of information available on the Internet, it is impractical as well as impossible for a person (e.g., a network user) to manually search throughout the Internet for specific pieces of information. Instead, most network users rely on different types of computer-implemented tools to help them locate the desired network resources or contents. One of the most commonly and widely used computer-implemented tools is a search engine, such as the search engines provided by Microsoft® Inc. (http://www.bing.com), Yahoo!® Inc. (http://search.yahoo.com), and Google™ Inc. (http://www.google.com). To search for information relating to a specific subject matter or topic on the Internet, a network user typically provides a short phrase or a few keywords describing the subject matter, often referred to as a “search query” or simply “query”, to a search engine. The search engine conducts a search based on the search query using various search algorithms and generates a search result that identifies network resources or contents that are most likely to be related to the search query. The network resources or contents are presented to the network user, often in the form of a list of links, each link being associated with a different network document (e.g., a web page) that contains some of the identified network resources or contents. In particular embodiments, each link is in the form of a Uniform Resource Locator (URL) that specifies where the corresponding document is located and the mechanism for retrieving it. The network user is then able to click on the URL links to view the specific network resources or contents contained in the corresponding document as he wishes.

Sophisticated search engines implement many other functionalities in addition to merely identifying the network resources or contents as a part of the search process. For example, a search engine usually ranks the identified network resources or contents according to their relative degrees of relevance with respect to the search query, such that the network resources or contents that are relatively more relevant to the search query are ranked higher and consequently are presented to the network user before the network resources or contents that are relatively less relevant to the search query. The search engine may also provide a short summary of each of the identified network resources or contents.

There are continuous efforts to improve the qualities of the search results identified by the search engines. Accuracy, completeness, presentation order, and speed are but a few of the performance aspects of the search engines for improvement.

### SUMMARY

The present disclosure generally relates to improving the quality of search results indentified for search queries by search engines and more specifically relates to personalizing the search results indentified for the search queries having implicit and general local intent.

Particular embodiments access a first set of search queries comprising one or more first search queries; extract one or more features based on the first set of search queries, train a search-query classifier using the features; access a second search query provided by a user; determine whether the second search query has implicit and general local intent using the search-query classifier; if the second search query has implicit and general local intent, then: determine a location associated with the user; and identify a search result in response to the second search query based at least in part on the location associated with the user; and present the search result to the user. In particular embodiments, the features comprise one or more of: one or more first features indicating, for each of the first search queries, whether the first search query has local intent; one or more second features indicating, for each of the first search queries that have local intent, whether the local intent is implicit; and one or more third features indicating, for each of the first search queries that have local intent, whether the local intent is general;

These and other features, aspects, and advantages of the disclosure are described in more detail below in the detailed description and in conjunction with the following figures.

### BRIEF DESCRIPTION OF THE DRAWINGS

FIG. 1 (prior art) illustrates an example search result.

FIG. 2 illustrates an example method for personalizing search results identified for search queries having implicit and general local intent.

FIG. 3 illustrates an example network environment.

FIG. 4 illustrates an example computer system.

### DETAILED DESCRIPTION

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Particular embodiments personalize search results identified for search queries having implicit and general local intent. In particular embodiments, a search-query classifier, or simply a query classifier, may be trained through machine learning with various types of features extracted from a set of search queries so that the query classifier may be able determine whether a particular search query has implicit and general local intent. In particular embodiments, for a search query issued by a network user, or simply a user, to a search engine, if the query classifier determines that the search query has implicit and general local intent, then the user's location information is taken into consideration when a search result is identified for the search query.

A search engine is a computer-implemented tool designed to search for information relevant to specific subject matters or topics on a network, such as the Internet, the World Wide Web, or an Intranet. To conduct a search, a network user may issue a search query to the search engine. The search query generally contains one or more words that describe a subject matter. In response, the search engine may identify one or more network resources that are likely to be related to the search query, which may collectively be referred to as a “search result” identified for the search query. The network resources are usually ranked and presented to the network user according to their relative degrees of relevance to the search query.

Sophisticated search engines implement many other functionalities in addition to merely identifying the network resources as a part of the search process. For example, a search engine usually ranks the network resources identified for a search query according to their relative degrees of relevance with respect to the search query, such that the network resources that are relatively more relevant to the search query are ranked higher and consequently are presented to the network user before the network resources that are relatively less relevant to the search query. The search engine may also provide a short summary of each of the identified network resources.

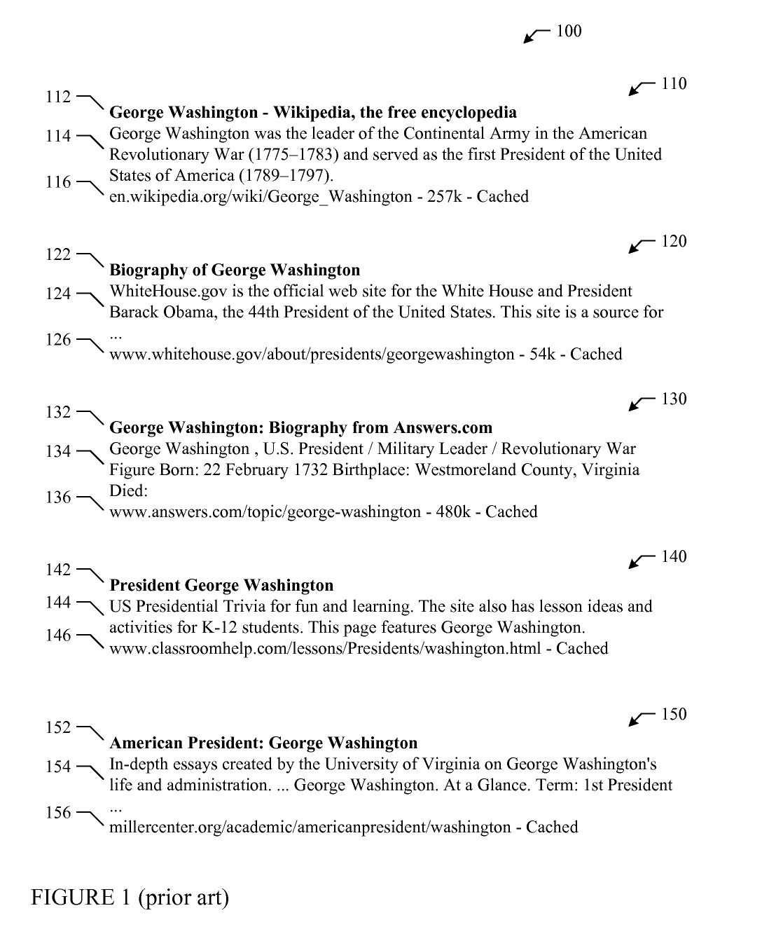

FIG. 1 illustrates an example search result 100 that identifies five network resources and more specifically, five web pages 110, 120, 130, 140, 150. Search result 100 is generated in response to an example search query “President George Washington”. Note that only five network resources are illustrated in order to simplify the discussion. In practice, a search result may identify hundreds, thousands, or even millions of network resources. Network resources 110, 120, 130, 140, 150 each includes a title 112, 122, 132, 142, 152, a short summary 114, 124, 134, 144, 154 that briefly describes the respective network resource, and a clickable link 116, 126, 136, 146, 156 in the form of a URL. For example, network resource 110 is a web page provided by WIKIPEDIA that contains information concerning George Washington. The URL of this particular web page is “en.wikipedia.org/wiki/George_Washington”.

Network resources 110, 120, 130, 140, 150 are presented according to their relative degrees of relevance to search query “President George Washington”. That is, network resource 110 is considered somewhat more relevant to search query “President George Washington” than network resource 120, which is in turn considered somewhat more relevant than network resource 130, and so on. Consequently, network resource 110 is presented first (i.e., at the top of search result 100) followed by network resource 120, network resource 130, and so on. To view any of network resource 110, 120, 130, 140, 150, the network user requesting the search may click on the individual URLs of the specific web pages.

There are continuous efforts to improve the qualities of the search results identified by the search engines. In particular instances, search results generated for search queries having implicit and general local intent may be further improved by taking into consideration the location information of the users issuing the search queries to search engines.

Sometimes, a search query describes a subject matter that may be associated with one or more geographical or physical locations. For example, search query “Disneyland” is likely to be connected with Anaheim, Calif.; search query “Metropolitan Museum of Art” is likely to be connected with New York City; and search query “Lincoln Memorial” is likely to be connected with Washington D.C. Other times, a search query describes a subject matter that may be independent of (i.e. having no strong connection or association with) any specific location. For example, search queries such as “Harry Potter”, “Angelina Jolie”, “Safeway coupons”, or “MP3 player” are unlikely to be connected with any specific physical location. With search query “Angelina Jolie”, the user is more likely to be interested in information concerning the actress herself, regardless of where she is located at the moment. With search query “Safeway coupons”, the coupons may be used at any Safeway stores, regardless of where a particular store is located. In the context of the present disclosure, a search query describing a subject matter that is likely to be associated with one or more physical locations is considered to have “local intent”.

Sometime, for a search query that is likely to be associated with one or more locations (i.e., a search query that has local intent”), the locations may be explicitly indicated by the words of the search query. For example, search queries such as “Paris Eiffel Tower”, “Westminster Abbey in London”, “Chinese restaurants in San Francisco”, or “Walmart San Jose” each contain words that explicitly specify the locations of the subject matters or the information the users search for. With search query “Walmart San Jose”, using words “San Jose”, the user explicitly indicates that the Walmart stores in which the user is interested should be located in the city of San Jose. In the context of the present disclosure, a search query that includes words explicitly indicating a physical location connected with the subject matter the user searches for is considered to have “explicit local intent”. Other times, for a search query that has local intent, the locations may be implicitly indicated by the words of the search query. That is, there is no word in the search query that specifically refers to a location. Instead, the local intent of the search query may be inferred from the words of the search query. For example, search queries such as “Italian restaurants”, “Apple stores”, or “movie theaters” describe subject matters that are likely to be associated with certain specific locations (e.g., an Italian restaurant typically exits in the real world and has a physical address), and yet, there is no word in these search queries that explicitly indicate any physical location. In such cases, the local intent of the search queries may be inferred from the words of the search queries. For example, since search query “Apple stores” describe retail stores that exist in the real world, these stores are most likely to be located somewhere and thus have actual locations. In the context of the present disclosure, a search query that includes words from which local intent may be inferred and yet does not include any word that explicitly indicates any location is considered to have “implicit local intent”.

Sometimes, for a search query that has local intent, the local intent may be specific. That is, there are only a relatively few specific locations that may be associated with the search query. In the examples above, search query “Disneyland” is most likely to be connected with Anaheim; search query “Metropolitan Museum of Art” is most likely to be connected with New York City; and search query “Lincoln Memorial” is most likely to be connected with Washington D.C. In each of these cases, the location associated with the example search query is fairly unique. For example, there is only one Lincoln Memorial, and it is located on the National Mall in Washington D.C. Thus, there is only one location (i.e., Washington D.C.) associated with search query “Lincoln Memorial”. Similarly, there is only one location, Anaheim, associated with search query “Disneyland”. In the context of the present disclosure, a search query that describes a subject matter that is likely to be associated with a relatively small number of physical locations is considered to have “specific local intent”. Other times, for a search query that has local intent, the local intent may be general. That is, the subject matter described by the search query may be associated with many possible locations. For example, there may be many Italian restaurants located in different cities, different states, and different countries. Thus, search query “Italian restaurants” may be connected with many possible locations. Furthermore, the connections that search query “Italian restaurants” has with the many possible locations may be similarly strong or similarly weak, since the words of search query “Italian restaurants” do not suggest which location the user is more or less interested in locating the Italian restaurants. In other words, there is no bias toward any of the locations possibly associated with search query “Italian restaurants”. In the context of the present disclosure, a search query that describes a subject matter that is likely to be associated with a relatively large number of physical locations and there is no strong bias toward any of the possibly associated locations is considered to have “general local intent”.

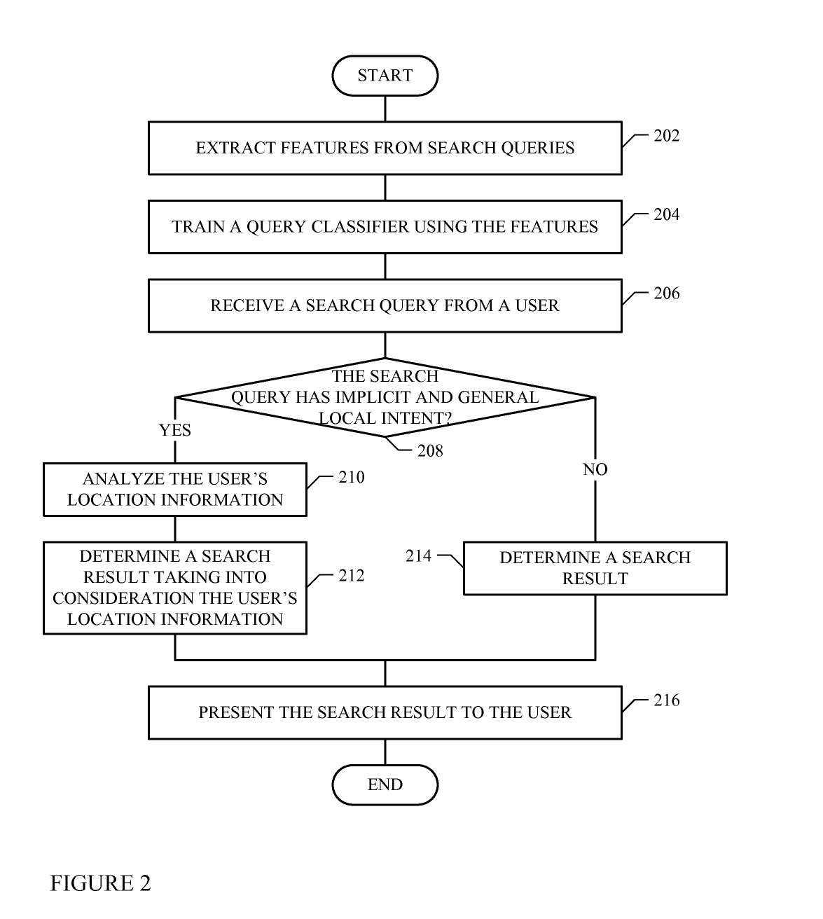

For a search query that has local intent that is both implicit and general, particular embodiments may further personalize the search result identified for that search query. FIG. 2 illustrates an example method for personalizing search results identified for search queries having implicit and general local intent. In particular embodiments, a search-query classifier, or simply a query classifier, is used to determine whether a given search query has implicit and general local intent. In particular embodiments, the query classifier is a non-linear support vector machine (SVM) classifier. Given a search query, the non-linear SVM classifier may predict the likelihood or the probability that the search query has implicit and general local intent. In particular embodiments, the likelihood or the probability is represented as a real number. In particular embodiments, the probability predicted for the search query is then compared against a predetermined threshold requirement. If the predicted probability satisfies the threshold requirement, the search query is considered to have implicit and general local intent; otherwise, if the predicted probability does not satisfy the threshold requirement, the search query is considered not to have implicit and general local intent.

Particular embodiments may train a query classifier through machine learning so that the query classifier is able to automatically determine whether a particular search query has implicit and general local intent. Machine learning is a scientific discipline that is concerned with the design and development of algorithms that allow computers to learn based on data. The computational analysis of machine learning algorithms and their performance is a branch of theoretical computer science known as computational learning theory. The desired goal is to improve the algorithms through experience. The data are applied to the algorithms in order to “train” the algorithms, and the algorithms are adjusted (i.e., improved) based on how they respond to the data. The data are thus often referred to as “training data”. Typically, a machine learning algorithm is organized into a taxonomy based on the desired outcome of the algorithm. Examples of algorithm types may include supervised learning, unsupervised learning, semi-supervised learning, reinforcement learning, transduction, and learning to learn. With transduction, the algorithms typically try to predict new outputs for new inputs based on training inputs, training outputs, and test inputs.

In particular embodiments, the triaging data applied to a query classifier may include various types of features (step 202). To obtain these training features, particular embodiments may construct at least three sets of search queries and at least three language models for the three sets of search queries respectively. Various types of training features may then be determined from these sets of search queries and language models. For clarification purpose, in the context of the present disclosure, the three sets of search queries are referred to as the first set of search queries, denoted as S₁^{Q}, the second set of search queries, denoted as S₂^{Q}, and the third set of search queries, denoted as S₃^{Q}. Similarly, the three language models are referred to as the first language model (corresponding to the first set of search queries), the second language model (corresponding to the second set of search queries), and the third language model (corresponding to the third set of search queries).

Often, search engines maintain records of the search queries received from network users. These records may be referred to as query logs. Particular embodiments may construct the first set of search queries from one or more query logs. Thus, in particular embodiments, the first set of search queries includes search queries received from network users in their original form. There may be any number of search queries included in the first set of search queries. To obtain sufficient features to train the query classifier well, particular embodiments may select a sufficient number of search queries (e.g., a few hundred to a few thousand distinct search queries) to form the first set of search queries.

A search query typically includes one or more words, and sometimes, a search query may include one or more words representing a location. For a search query that includes words representing a location, there may be some additional words included in the search query that, while they do not represent any location, they may represent a topic or subject matter (i.e., a context) associated with the location. For example, search query “Paris Eiffel Tower” includes three words, one of which (i.e., Paris) represents a location. The other two words (i.e., Eiffel Tower) represent a subject matter associated with the location. In the context of the present disclosure, the words in a search query that do not represent any location are considered to represent a context and are referred to as “context words”. In contrast, the words in the search query that do represent a location are referred to as “location words”. Note that a search query may or may not include any location word. Conversely, a search query may include only location words (e.g., search query “New York City”). Thus, a search query may include one or more context words or one or more location words or both.

Particular embodiments may use a query tagger, also referred to as a concept tagger, to automatically parse and conceptually tag the words in each of the search queries in the first set of search queries. In particular embodiments, a search query may be parsed so that the words in the search query are associated with specific concepts. In particular embodiments, there may be a predetermined set of concepts used to tag the individual words of a search query. For example and without limitation, the predetermined concepts may include business name, business type, product name, product model, product manufacture, person name, person first name, person last name, domain name, IP address, URL, city, state, or country. The present disclosure contemplates any suitable or applicable concepts. Consequently, once each search query from the first set of search queries has been conceptually tagged using a concept tagger, particular embodiments may determine whether any particular search query from the first set of search queries includes one or more words that represent a location.

The query tagger may be based on a mathematical model, such as, for example and without limitation, conditional random field (CRF, a discrimination probabilistic model often used for the labeling or parsing of sequential data), hidden Markov model (HMM, a statistical model often used in temporal pattern recognition applications), finite state machine (FSM), or maximum entropy model. The present disclosure contemplates any suitable query tagger. For example, a query tagger may be implemented similarly as the Stanford Named Entity Recognizer (NER) developed by the Stanford Natural Language Processing Group. The CRFClassifier, which is a software implementation of the Named Entity Recognizer, labels sequences of words in a text (e.g., a search query) that are the names of things, such as person and company names or gene and protein names. The CRFClassifier may be extended to label other concepts on a search query.

Particular embodiments may extract from the first set of search queries all those search queries that include words representing locations based on the result of the concept tagging to form the second set of search queries. In other words, the second set of search queries is a subset of the first set of search queries that includes only search queries from the first set of search queries that have location words. Experiments suggest that for a typical set of search queries obtained from the query logs of a search engine, approximately 20% of the search queries in the set include words that represent locations.

To construct the third set of search queries, which may also be considered as a subset of the first set of search queries, particular embodiments may remove, from each of the search queries from the second set of search queries, those words that represent locations (i.e., the location words in each of the search queries). The remaining context words of the search queries form the third set of search queries (i.e., a set of search queries having only their context words). Thus, the third set of search queries includes those search queries extracted from the first set of search queries that originally have words representing locations but with those location words removed. In other words, the third set of search queries includes those search queries from the first set of search queries that originally have both context words and location words, but with their location words removed, leaving only their context words. Consequently, the third set of search queries may also be referred to as a set of contexts. In contrast, the second set of search queries includes those search queries from the first set of search queries that originally have both context words and location words and in their original form.

For example, suppose search queries “Paris Eiffel Tower”, “Westminster Abbey in London”, “Chinese restaurants in San Francisco”, and “Walmart San Jose” are included, among others, in the first set of search queries. Originally, they each include words that represent locations (e.g., Paris, London, San Francisco, San Jose) as well as words that represent contexts associated with the locations (e.g., Eiffel Tower, Westminster Abbey, Chinese restaurants, Walmart). These search queries are extracted from the first set of search queries to be included in the second set of search queries. Then, the location words in these search queries are removed, and the results are included in the third set of search queries. Thus, the third set of search queries may include, among others, “Eiffel Tower”, “Westminster Abbey”, “Chinese restaurants”, or “Walmart”, which are only the context words. On the other hand, suppose search queries “Italian restaurants”, “Apple stores”, or “movie theaters” are also included, among others, in the first set of search queries. Since these search queries do not include any location words, they are not extracted from the first set of search queries, and consequently, they do not become a part of the second set of search queries and the third set of search queries.

Particular embodiments may construct three language models for the three sets of search queries respectively. Again, a search query may include one or more words. Let Q denote a search query that includes n words, denoted as {w₁, . . . , wₙ}, where n is an integer and n>0. In particular embodiments, the first language model, the second language mode, and the third language model may each be a n-gram language model, where n may be any integer greater than 0. For example, a bi-gram language model considers two consecutive words in any search query, while a tri-gram language model considers three consecutive words in any search query, and so on. The present disclosure contemplates any suitable n-gram language model.

In particular embodiments, the training features may include the probabilities of the search queries having local intent (i.e., the probabilities of the search queries describing subject matters that are associated with locations in the real world). In the context of the present disclosure, let P(LI|Q) denote the probability that Q has local intent. Particular embodiments may determine P(LI|Q) as

$$P ( LI \vert Q ) = \frac{P ( {Q}^{L} )}{P ( Q )} , \qquad ( EQUATION 1 )$$

where P(Q^{L}) is the probably that Q may co-occur with a location (i.e., the probably that Q may include words referring to a location) in the first set of search queries, and P(Q) is the probably that Q appears in the first set of search queries. Particular embodiments may determine P(Q) and P(Q^{L}) based on the first language model and the third language model respectively.

In particular embodiments, for a given Q, P(Q) may be defined as the probability that Q appears in the first set of search queries, and P(Q^{L}) may be defined as the probability that Q appears in the third set of search queries (i.e., the set of contexts). That is,

$$P ( LI \vert Q ) = \frac{P ( {Q}^{L} )}{P ( Q )} = \frac{P ( {S}_{3}^{Q} \vert Q )}{P ( {S}_{1}^{Q} \vert Q )} , \qquad ( EQUATION 2 )$$

where P(S₁^{Q}|Q) denote the probability that Q is found in S₁^{Q}, and P (S₃^{Q}|Q) denote the probability that Q is found in S₃^{Q}. In particular embodiments, P(S₁^{Q}|Q) may be determined based on the first language model constructed on S₁^{Q}, and P(S₃^{Q}|Q) may be determined based on the third language model constructed on S₃^{Q}. In particular embodiments, the first language model and the third language model may be any suitable n-gram language model.

Using bi-gram language models as an example, in particular embodiments, P(S₁^{Q}|Q) may be calculated as

P(S₁^{Q}|Q)=P₁(w₁)P₁(w₂|w₁) . . . P₁(wₙ|wₙ₋₁) (EQUATION 3A),

where P₁(w₁) is the probability that w₁ (i.e., the first word in Q) is found among the words of the first set of search queries; P₁(w₂|w₁) is the probability that w₁w₂ (i.e., the first word in Q followed by the second word in Q) is found among the words of the first set of search queries given w₁ (i.e., the first word in Q); and P₁(wₙ|wₙ₋₁) is the probability that wₙ₋₁wₙ (i.e., the second from the last word in Q followed by the last word in Q) is found among the words of the first set of search queries given wₙ₋₁ (i.e., the second from the last word in Q). P(S₁^{Q}|Q) may then be the product of all the P₁( )'s. Similarly, P(S₂^{Q}|Q) may be calculated as

P(S₃^{Q}|Q)=P₃(w₁)P₃(w₂|w₁) . . . P3(wₙ|wₙ₋) (EQUATION 3B),

where P₃(w₁) is the probability that w₁ is found among the words of the third set of search queries; P₃(w₂|w₁) is the probability that w₁w₂ is found among the words of the third set of search queries given w₁; and P₃(wₙ|wₙ₋₁) is the probability that wₙ₋₁wₙ is found among the words of the third set of search queries given wₙ₋₁. P(S₃^{Q}|Q) may then be the product of all the P₃( )'s.

Alternatively, using tri-gram language models as an example, in particular embodiments, P(S₁^{Q}|Q) may be calculated as

P(S₁^{Q}|Q)=P₁(w₁)P₁(w₂|w₁)P₁(w₃|w₁w₂)P₁(w₄|w₂w₃) . . . P₁(wₙ|wₙ₋₂wₙ₋₁) (EQUATION 4A),

where P₁(w₁) is the probability that w₁ is found among the words of the first set of search queries; P₁(w₂|w₁) is the probability that w₁w₂ is found among the words of the first set of search queries given w₁; P₁(w₃|w₁w₂) is the probability that w₁w₂w₃ (i.e., the first word in Q followed by the second word in Q followed by the third word in Q) is found among the words of the first set of search queries given w₁w₂; P₁(w₄|w₂w₃) is the probability that w₂w₃w₄ (i.e., the second word in Q followed by the third word in Q followed by the fourth word in Q) is found among the words of the first set of search queries given w₂w₃; and P₁(wₙ|wₙ₋₂wₙ₋₁) is the probability that wₙ₋₂wₙ₋₁wₙ (i.e., the third from the last word in Q followed by the second from the last word in Q followed by the last word in Q) is found among the words of the first set of search queries given wₙ₋₂wₙ₋₁. P(S₁^{Q}|Q) may then be the product of all the P₁( )'s. Similarly, P(S₃^{Q}|Q) may be calculated as

P(S₃^{Q}|Q)=P₃(w₁)P₃(w₂|w₁)P₃(w₃|w₁w₂)P₃(w₄|w₂w₃) . . . P₃(wₙ|wₙ₋₂wₙ₋₁) (EQUATION 4B),

where P₃ (w₁) is the probability that w₁ is found among the words of the third set of search queries; P₂(w₂|w₁) is the probability that w₁w₂ is found among the words of the third set of search queries given w₁; P₃(w₃|w₁w₂) is the probability that w₁w₂w₃ is found among the words of the third set of search queries given w₁w₂; P₃(w₄|w₂w₃) is the probability that w₂w₃w₄ is found among the words of the third set of search queries given w₂w₃; and P₃(wₙ|wₙ₋₂wₙ₋₁) is the probability that wₙ₋₂wₙ₋₁wₙ is found among the words of the third set of search queries given wₙ₋₂wₙ₋₁. P(S₃^{Q}|Q) may then be the product of all the P₃( )'s.

As indicated above, in particular embodiments, the training features may include the probabilities of the search queries having local intent. In particular embodiments, the probabilities of the search queries having local intent may be calculated using EQUATION 2 in connection with EQUATIONS 3A and 3B, in case bi-gram language models are used, or in connection with EQUATIONS 4A and 4B, in case tri-gram language models are used.

In particular embodiments, the training features may include whether the search queries each contain words that explicitly represent locations (i.e., whether the search queries each contain location words). For example, search queries “Paris Eiffel Tower”, “Westminster Abbey in London”, “Chinese restaurants in San Francisco”, and “Walmart San Jose” each have words that explicitly represent locations. On the other hand, “Italian restaurants”, “Apple stores”, or “movie theaters” do not include words that explicitly represent locations. As described above, particular embodiments may use a concept tagger to parse and conceptually tag the words included in the search queries from the first set of search queries. Based on the result of the concept tagging, particular embodiments may determine which search queries from the first set of search queries include words that explicitly represent locations, and which search queries do not. In particular embodiments, the training features may include, for each of the search queries from the first set of search queries, an indicator whether that search query includes words that explicitly represent a location (e.g., a TRUE may indicate that a search query includes words that explicitly represent a location, and a FALSE may indicate that a search query does not include words that explicitly represent a location).

In particular embodiments, the training features may include, for each of those search queries from the first set of search queries that have local intent (e.g., those search queries whose probabilities of having local intent, P(LI/Q), satisfy a predetermined threshold requirement), whether the local intent is general or specific. As described above, in particular embodiments, a search query may have general local intent when that search query may be associated with a relatively large number of different locations, and the likelihoods that the search query is associated with the individual possible locations are relatively similar. On the other hand, a search query may have specific local intent when that search query may be associate with a relatively few number of different locations. For example, a search query that is associated with only one possible location (e.g., search queries such as “Disneyland” or “Carnegie Hall”) is considered to have very specific local intent. Consequently, in particular embodiments, whether a search query has general local intent may be determined based on the entropy of location distribution of the search query, denoted as E(L|Q), where L denotes the possible locations with which Q may be associated.

For a given Q, let C^{Q} denote the context, as represented by the context words, of Q. Particular embodiments may define, for a given Q, its entropy, E(L|Q), as

$$E ( L \vert Q ) = - {\sum }_{L} P ( L \vert {C}^{Q } ) log P ( L \vert {C}^{Q} ) , \qquad ( EQUATION 5 )$$

where, given a particular location, L, P(L|C^{Q}) denotes the probability that the context in Q (i.e., C^{Q}) is associated with L. Particular embodiments may calculate P(L|C^{Q}) based on the second set of search queries and the second language model, as

$$P ( L \vert {C}^{Q} ) = \frac{P ( L , {C}^{Q} )}{P ( {C}^{Q} )} , \qquad ( EQUATION 6 )$$

where P(L,C^{Q}) is the probability of C^{Q} co-occur with L (i.e., C^{Q} and L are found together) in the second set of search queries, and P(C^{Q}) is the probability of the particular word sequence C^{Q} found in the second set of search queries. In particular embodiments, the second language model may be any suitable n-gram language model, similar to the first language model and the third language model.

The context portion, C^{Q}, of a search query, Q, may include one or more words, denoted as {w₁, . . . , wₘ}, where m is an integer and n≧m>0. Using bi-gram language model as an example, for a given C, the m words may be segmented into a number of two-word segments. To determine the entropy of location distribution for Q that includes C^{Q}, particular embodiments may determine the entropy for each pair of words, and then determine the maximum, average, or mean entropy among all pairs of words. Note that different implementations may use either maximum entropy or average entropy or mean entropy or other suitable types entropy value among all pairs of words.

In particular embodiments, the training features may include the frequency of person name, including the frequency of the first names, the frequency of the last names, or the frequency of the full names, appearing in the first set of search queries. Person name may be considered a special type of entity that often co-occurs with location. However, many people may have the same first name, the same last name, or even the same full name. Thus, persons' names, especially popular names, may confuse the query classifier into thinking these persons' names have general local intent. For example, a store name, such as “Wal-mart”, may co-occur with different locations (e.g., “Wal-mart San Francisco”, “Wal-mart Los Angeles”, or “Wal-mart New York”) in the search queries provided by network users, but they all refer to the same chain store—Wal-mart. On the other hand, when a popular person name, such as “John”, is found together (i.e., co-occur) with different locations (e.g., “John San Francisco”, “John Los Angeles”, or “John New York”) in the search queries provided by network users, the name is more likely to refer to different people all having the same first name—John.

In particular embodiments, the training features may include the frequency of person name to be used in connection with the entropy of the location distribution of the search queries from the first set of search queries. Since many different persons may have the same name, its entropy of the conditional location distribution given query context may be relatively high. Therefore, detecting person name among the search queries may significantly improve the quality of the query classifier detecting implicit local intent among the search queries. More specifically, with the help of person-name frequency features, the query classifier may be able to take the person-name frequency into consideration and avoid classifying a search query that contains a popular person name as having general local intent. As described above, particular embodiments may use a concept tagger to parse and conceptually tag the words included in the search queries from the first set of search queries. If a word in a search query is a person name, the concept tagger may identify it as either a first name or a last name. Similarly, the concept tagger may identify multiple words in a search query that are a person's full name. Based on the result of the concept tagging, particular embodiments may determine which search queries from the first set of search queries include words that represent person name, including first name, last name, or full name. The information may then be used to determine the frequency of person name found in the first set of search queries.

In particular embodiments, the training features may include the domain weight appearing in the first set of search queries. A network domain name typically is not associated with any specific physical location (i.e., location in the real world). For example, domain names such as “www.youtube.com” or “www.facebook.com” typically refer to virtual address (e.g., websites) on the Internet instead of physical locations in the read world. Thus, if a search query contains a domain name, particular embodiments may consider the probability that the search query conveys implicit local intent as being relatively low. Again, particular embodiments may determine which search queries from the first set of search queries contain domain names and which search queries do not based on the result of the concept tagging. Particular embodiments may use the link flux of the domain names found in the first set of search queries as the domain weight measurement. The link flux of the domain names indicate the degree of popularity of the domain names based on how often or how many times the domain names are accessed or clicked by the network users. Particular embodiments may then rank the domain names found in the first set of search queries based on their popularity to determine the more popular domain names. If a search query contains a popular domain name, then particular embodiments may consider that search query as having a relatively low probability of having implicit local intent.

Particular embodiments may sort all the domain names, and more specifically the URLs identifying the domain names, clicked by network users during a year according to the frequency of the user clicking the domain names. The frequency may then included as a part of the training features for training the query classifier.

The training features may include other types of features. The present disclosure contemplates any suitable types of features that may be used to train the query classifier. In addition, in particular embodiments, human judgments may be incorporated into the training of the query classifier, represented as additional types of features. For example, individual search queries may be presented to a person and the person may manually determine whether each of the search queries has implicit and general local intent. Particular embodiments may then apply all the features to the query classifier to train the query classifier via the process of machine learning (step 204). Of course, the query classifier may be trained repeatedly using different sets of features in order to improve the performance of the query classifier. Once trained, the query classifier may be able to detect general and implicit local intent in a given search query.

In particular embodiments, a trained query classifier may be incorporated into a search engine or used in connection with a search query. Particular embodiments may use the query classifier to determine whether search queries issued to the search engine by network users have implicit and general local intent. Suppose a network user provides a search query to a search engine (step 206). In particular embodiments, the query classifier may be used to automatically determine whether that search query has implicit and general local intent (step 208). In particular embodiments, the query classifier may calculate a probability of the search query having implicit and general local intent. In particular embodiments, if the probability satisfies a predetermined threshold requirement, then the search query is considered as having implicit and general local intent.

In particular embodiments, if the search query does not have implicit and general local intent (step 208, “NO”), then the search engine may identify a search result in response to the search query using an existing (i.e., traditional) search process (step 214). On the other hand, if the search query does have implicit and general local intent (step 208, “YES”), then the search engine may identify the search result in response to the search query taking into consideration, among other factors, the location information of the network user issuing the search query to the search engine.

Particular embodiments may use a user-location analyzer to analyze the location information of the network user issuing the search query to the search engine (step 210). Based on the location information of the network user, particular embodiments may determine a particular physical location associated with the network user. The location information of the network user may come from various sources. The present disclosure contemplates any suitable sources for determining a physical location associated with the network user issuing the search query to the search engine. As a first example, the Internet Protocol (IP) address of the client device used by the network user to access the search engine may be mapped to a city or a zip code using IP address information stored in various databases. Thus, the IP address of the client device used by the network user may be used to determine the location of the network user at the time when he issues the search query to the search engine. As a second example, if the client device used by the network user is a wireless device, its wireless signals may be used to triangulate the physical location of the wireless device or the access point associated with the wireless device may be used to determine the physical location of the wireless device, and through it the location of the network user. As a third example, the network user's online profile may include the network user's location information, such as the network user's home or work address. The network user may have identified a default address associated with his online profile. Such information included in the network user's online profile may be used to determine a physical location associated with the network user. In particular embodiments, the location corresponding to the IP address of the client device used by the network user may be compared against the default address specified in the network user's online profile. If the two locations are relatively far apart, this may suggest that the network user has traveled to a distant location outside of his usual areas. In such cases, particular embodiments may either use the location corresponding to the IP address of the client device as the physical location associated with the network user or choose not to take into consideration any location associated with the network user when identifying the search result for the network user (i.e., identifying the search result in response to the search query using an existing search process). As a fourth example, the network user's historical network activities (e.g., preserved in records by various websites) may be used to determine the physical location the network user most frequently searches for. The most-frequently-searched-for location may be considered as the location associated with the network user.

In particular embodiments, if the user-location analyzer is unable to determine any physical location associated with the network user (e.g., when no location information of the network user is available or accessible), then the search engine may identify the search result in response to the search query using an existing search process. On the other hand, if a physical location is determined to be associated with the network user, then the search engine may identify the search result in response to the search query taking into consideration, among other factors, the physical location associated with the network user (step 212).

To take the location associated with the network user into consideration when identifying the search result in response to the search query, particular embodiments may add the location to the original search query to form a new search query and then identify the search result using the new search query. For example, if the original search query issued by the network user to the search engine is “Italian restaurants” and the location associated with the network user has been determined to be “San Francisco”, a new search query may be formed as “Italian restaurants San Francisco” by appending the determined location to the original search query. The new search query is then issued to the search engine to obtain the search result for the network user. Because the location “San Francisco” is now included in the new search query, based on which the search result is identified, the search engine is more likely to find Italian restaurants located in San Francisco.

Alternatively, particular embodiments may identify a search result using the original search query and then adjust the search result by increasing the ranks of those network resources included in the search result that match the location associated with the network user. Consequently, the network resources that match the location associated with the network user are ranked higher and presented to the network user before those network resources that do not match the location associated with the network user. For example, if the original search query issued by the network user to the search engine is “Italian restaurants” and the location associated with the network user has been determined to be “San Francisco”, the search engine may first identify a search result using the original search query “Italian restaurants”. Then, those Italian restaurants included in the search result that are located in San Francisco (i.e., having addresses in San Francisco) may be moved up in rank so that they are presented to the network user first, before those Italian restaurants included in the search result that are located in other cities.

Once the search result has be generated, particular embodiments may present the search result to the network user (step 216) using any suitable method, such as in a web page transmitted from the search engine to the web browser on the client device used by the network user.

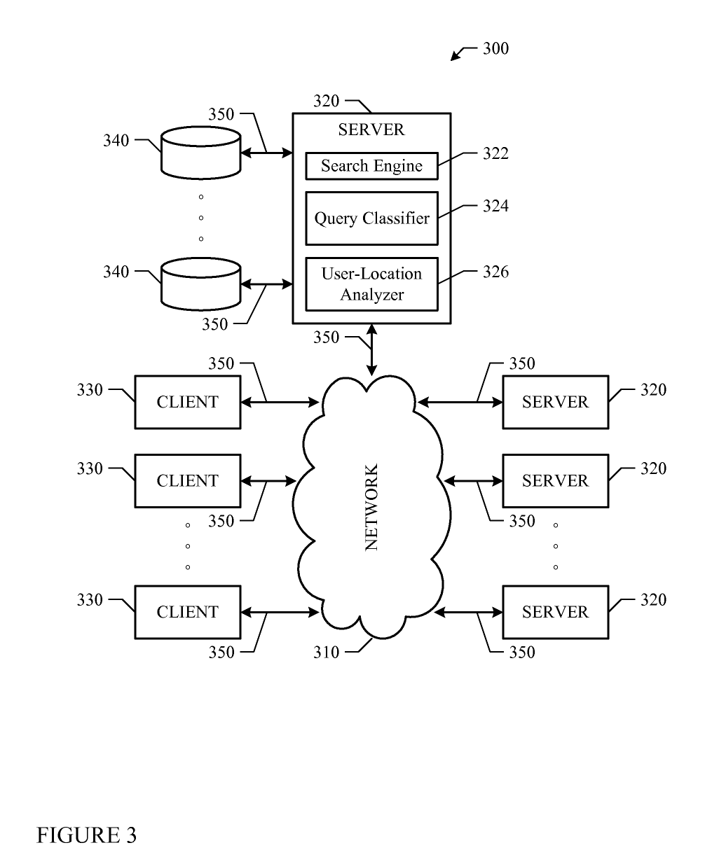

Particular embodiments may be implemented in a network environment. FIG. 3 illustrates an example network environment 300. Network environment 300 includes a network 310 coupling one or more servers 320 and one or more clients 330 to each other. In particular embodiments, network 310 is an intranet, an extranet, a virtual private network (VPN), a local area network (LAN), a wireless LAN (WLAN), a wide area network (WAN), a metropolitan area network (MAN), a portion of the Internet, or another network 310 or a combination of two or more such networks 310. The present disclosure contemplates any suitable network 310.

One or more links 350 couple a server 320 or a client 330 to network 310. In particular embodiments, one or more links 350 each includes one or more wireline, wireless, or optical links 350. In particular embodiments, one or more links 350 each includes an intranet, an extranet, a VPN, a LAN, a WLAN, a WAN, a MAN, a portion of the Internet, or another link 350 or a combination of two or more such links 350. The present disclosure contemplates any suitable links 350 coupling servers 320 and clients 330 to network 310.

In particular embodiments, each server 320 may be a unitary server or may be a distributed server spanning multiple computers or multiple datacenters. Servers 320 may be of various types, such as, for example and without limitation, web server, news server, mail server, message server, advertising server, file server, application server, exchange server, database server, or proxy server. In particular embodiments, each server 320 may include hardware, software, or embedded logic components or a combination of two or more such components for carrying out the appropriate functionalities implemented or supported by server 320. For example, a web server is generally capable of hosting websites containing web pages or particular elements of web pages. More specifically, a web server may host HTML files or other file types, or may dynamically create or constitute files upon a request, and communicate them to clients 330 in response to HTTP or other requests from clients 330. A mail server is generally capable of providing electronic mail services to various clients 330. A database server is generally capable of providing an interface for managing data stored in one or more data stores.

In particular embodiments, a server 320 may include a search engine 322, a query classifier 324, and a user-location analyzer 326. Search engine 322 may be capable of identifying search results in response to search queries issued to it by users at clients 330. Query classifier 324 may be capable of determining whether a particular search query received at search engine 322 has implicit and general local intent. User-location analyzer 326 may be capable of determining a location associated with a user issuing a search query to search engine 322. Alternatively, in particular embodiments, query classifier 324 and user-location analyzer 326 may be a part of search engine 322.

In particular embodiments, one or more data storages 340 may be communicatively linked to one or more severs 320 via one or more links 350. In particular embodiments, data storages 340 may be used to store various types of information. In particular embodiments, the information stored in data storages 340 may be organized according to specific data structures. In particular embodiments, each data storage 340 may be a relational database. Particular embodiments may provide interfaces that enable servers 320 or clients 330 to manage, e.g., retrieve, modify, add, or delete, the information stored in data storage 340.

In particular embodiments, each client 330 may be an electronic device including hardware, software, or embedded logic components or a combination of two or more such components and capable of carrying out the appropriate functionalities implemented or supported by client 330. For example and without limitation, a client 330 may be a desktop computer system, a notebook computer system, a netbook computer system, a handheld electronic device, or a mobile telephone. The present disclosure contemplates any suitable clients 330. A client 330 may enable a network user at client 330 to access network 330. A client 330 may enable its user to communicate with other users at other clients 330.

A client 330 may have a web browser 332, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 330 may enter a Uniform Resource Locator (URL) or other address directing the web browser 332 to a server 320, and the web browser 332 may generate a Hyper Text Transfer Protocol (HTTP) request and communicate the HTTP request to server 320. Server 320 may accept the HTTP request and communicate to client 330 one or more Hyper Text Markup Language (HTML) files responsive to the HTTP request. Client 330 may render a web page based on the HTML files from server 320 for presentation to the user. The present disclosure contemplates any suitable web page files. As an example and not by way of limitation, web pages may render from HTML files, Extensible HyperText Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In particular embodiments, a client 330 enables its user to access services provided by servers 320. For example, users at clients 330 may access search engine 322, including issuing search queries to and receiving search results from search engine 322.

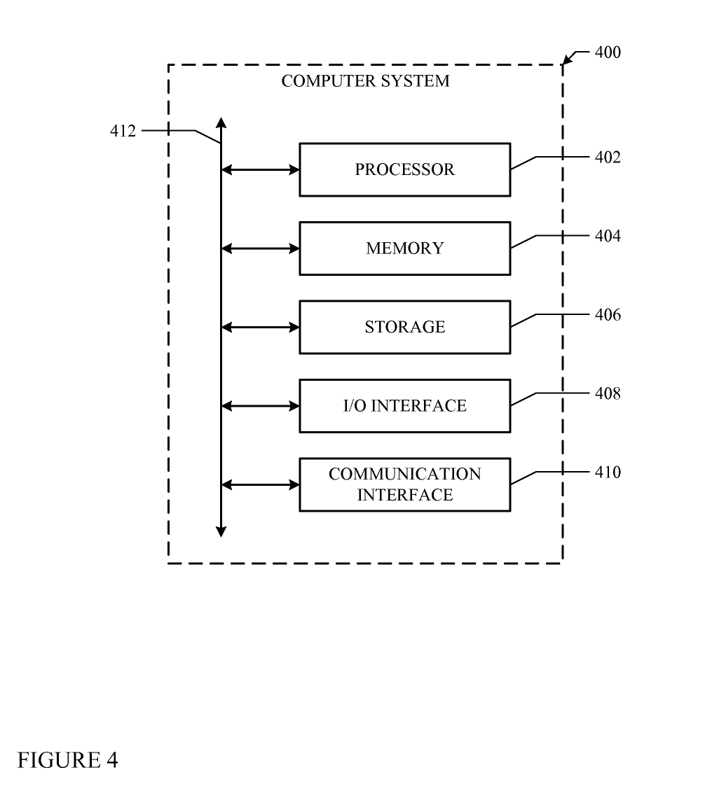

Particular embodiments may be implemented on one or more computer systems. FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 400 may include one or more computer systems 400; be unitary or distributed; span multiple locations; span multiple machines; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. The present disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. The present disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include an HDD, a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch-screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In particular embodiments, a computer-readable storage medium implements one or more portions of processor 402 (such as, for example, one or more internal registers or caches), one or more portions of memory 404, one or more portions of storage 406, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising, by one or more computer systems:
accessing a first set of search queries comprising one or more first search queries;
extracting one or more features based on the first set of search queries, the features comprising one or more of:
one or more first features indicating, for each of the first search queries, whether the first search query has local intent;
one or more second features indicating, for each of the first search queries that have local intent, whether the local intent is implicit; and
one or more third features indicating, for each of the first search queries that have local intent, whether the local intent is general;
training a search-query classifier using the features;
accessing a second search query provided by a user;
determining whether the second search query has implicit and general local intent using the search-query classifier;
if the second search query has implicit and general local intent, then:
determining a location associated with the user; and
identifying a search result in response to the second search query based at least in part on the location associated with the user; and
presenting the search result to the user.

2. The method recited in claim 1, wherein the features further comprise one or more of:
one or more fourth features indicating a frequency of person names among the first search queries; and
one or more fifth features indicating a weight of domain names among the first search queries.

3. The method recited in claim 1, wherein extracting the features based on the first set of search queries comprises:
constructing a second set of search queries comprising one or more of the first search queries in the first set of search queries, wherein each of the first search queries in the second set of search queries comprises one or more words that represent a location;
for each of the first search queries in the second set of search queries, removing the words that represent the location to obtain a modified first search query;
constructing a third set of search queries comprising the modified first search queries;
constructing a first language model based on the first set of search queries;
constructing a second language model based on the second set of search queries;
constructing a third language model based on the third set of search queries; and
extracting the features based on the first language model, the second language model, and the third language model.

4. The method recited in claim 1, wherein:
the search-query classifier is a non-linear support vector machine (SVM) classifier that, given a search query, predicts a probability that the search query has implicit and general local intent; and
the search query has implicit and general local intent if the probability satisfies a predetermined threshold requirement.

5. The method recited in claim 1, wherein if the second search query has implicit and general local intent, then identifying the search result in response to the second search query and based at least in part on the location associated with the user comprises:
constructing a third search query comprising the second search query and the location associated with the user; and
identifying the search result in response to the third search query.

6. The method recited in claim 1, wherein if the second search query has implicit and general local intent, then identifying the search result in response to the second search query and based at least in part on the location associated with the user comprises:
identifying a plurality of network resources in response to the second search query;
ranking the network resources based at least in part on the location associated with the user; and
constructing the search result comprising the ranked network resources.

7. The method recited in claim 1, further comprising if the second search query does not have implicit and general local intent, then identifying the search result in response to the second search query.

8. A system, comprising:
a memory comprising instructions executable by one or more processors; and
one or more processors coupled to the memory and operable to execute the instructions, the one or more processors being operable when executing the instructions to:
access a first set of search queries comprising one or more first search queries;
extract one or more features based on the first set of search queries, the features comprising one or more of:
one or more first features indicating, for each of the first search queries, whether the first search query has local intent;
one or more second features indicating, for each of the first search queries that have local intent, whether the local intent is implicit; and
one or more third features indicating, for each of the first search queries that have local intent, whether the local intent is general;
train a search-query classifier using the features;
access a second search query provided by a user;
determine whether the second search query has implicit and general local intent using the search-query classifier;
if the second search query has implicit and general local intent, then:
determine a location associated with the user; and
identify a search result in response to the second search query based at least in part on the location associated with the user; and
present the search result to the user.

9. The system recited in claim 8, wherein the features further comprise one or more of:
one or more fourth features indicating a frequency of person names among the first search queries; and
one or more fifth features indicating a weight of domain names among the first search queries.

10. The system recited in claim 8, wherein to extract the features based on the first set of search queries comprises:
construct a second set of search queries comprising one or more of the first search queries in the first set of search queries, wherein each of the first search queries in the second set of search queries comprises one or more words that represent a location;
for each of the first search queries in the second set of search queries, remove the words that represent the location to obtain a modified first search query;
construct a third set of search queries comprising the modified first search queries;
construct a first language model based on the first set of search queries;
construct a second language model based on the second set of search queries;
construct a third language model based on the third set of search queries; and
extract the features based on the first language model, the second language model, and the third language model.

11. The system recited in claim 8, wherein:
the search-query classifier is a non-linear support vector machine (SVM) classifier that, given a search query, predicts a probability that the search query has implicit and general local intent; and
the search query has implicit and general local intent if the probability satisfies a predetermined threshold requirement.

12. The system recited in claim 8, wherein if the second search query has implicit and general local intent, then identifying the search result in response to the second search query and based at least in part on the location associated with the user comprises:
construct a third search query comprising the second search query and the location associated with the user; and
identify the search result in response to the third search query.

13. The system recited in claim 8, wherein if the second search query has implicit and general local intent, then identifying the search result in response to the second search query and based at least in part on the location associated with the user comprises:
identify a plurality of network resources in response to the second search query;
rank the network resources based at least in part on the location associated with the user; and
construct the search result comprising the ranked network resources.

14. The system recited in claim 8, wherein the processors are further operable when executing the instructions to, if the second search query does not have implicit and general local intent, then identify the search result in response to the second search query.

15. One or more computer-readable storage media embodying software operable when executed by one or more computer systems to:
access a first set of search queries comprising one or more first search queries;
extract one or more features based on the first set of search queries, the features comprising one or more of:
one or more first features indicating, for each of the first search queries, whether the first search query has local intent;
one or more second features indicating, for each of the first search queries that have local intent, whether the local intent is implicit; and
one or more third features indicating, for each of the first search queries that have local intent, whether the local intent is general;
train a search-query classifier using the features;
access a second search query provided by a user;
determine whether the second search query has implicit and general local intent using the search-query classifier;
if the second search query has implicit and general local intent, then:
determine a location associated with the user; and
identify a search result in response to the second search query based at least in part on the location associated with the user; and
present the search result to the user.

16. The media recited in claim 15, wherein the features further comprise one or more of:
one or more fourth features indicating a frequency of person names among the first search queries; and
one or more fifth features indicating a weight of domain names among the first search queries.

17. The media recited in claim 15, wherein to extract the features based on the first set of search queries comprises:
construct a second set of search queries comprising one or more of the first search queries in the first set of search queries, wherein each of the first search queries in the second set of search queries comprises one or more words that represent a location;
for each of the first search queries in the second set of search queries, remove the words that represent the location to obtain a modified first search query;
construct a third set of search queries comprising the modified first search queries;
construct a first language model based on the first set of search queries;
construct a second language model based on the second set of search queries;
construct a third language model based on the third set of search queries; and
extract the features based on the first language model, the second language model, and the third language model.

18. The media recited in claim 15, wherein:
the search-query classifier is a non-linear support vector machine (SVM) classifier that, given a search query, predicts a probability that the search query has implicit and general local intent; and
the search query has implicit and general local intent if the probability satisfies a predetermined threshold requirement.

19. The media recited in claim 15, wherein if the second search query has implicit and general local intent, then identifying the search result in response to the second search query and based at least in part on the location associated with the user comprises:
construct a third search query comprising the second search query and the location associated with the user; and
identify the search result in response to the third search query.

20. The media recited in claim 15, wherein if the second search query has implicit and general local intent, then identifying the search result in response to the second search query and based at least in part on the location associated with the user comprises:
identify a plurality of network resources in response to the second search query;
rank the network resources based at least in part on the location associated with the user; and
construct the search result comprising the ranked network resources.

21. The media recited in claim 15, wherein the software is further operable when executed by the computer systems to, if the second search query does not have implicit and general local intent, then identify the search result in response to the second search query.
